(19) United States
(12) Patent Application Publication
(10) Pub. No.: US 2003/0036939 A1
(43) Pub. Date: Feb. 20, 2003

(54) Method and system configure to manage a maintenance process

(76) Inventors: Abelardo A. Flores, Santiago (CL); James W. McCaherty, Chillicothe, IL (US)

Correspondence Address: CATERPILLAR INC., 100 N.E. ADAMS STREET, PATENT DEPT., PEORIA, IL, 616296490

(21) Appl. No.: 10/123,736

(22) Filed: Apr. 16, 2002

Related U.S. Application Data
(60) Provisional application No. 60/306,905, filed on Jul. 20, 2001.

(51) Int. Cl. G06F 17/60

(52) U.S. Cl. 705/8; 702/184

(57) ABSTRACT

The present invention includes a method and system configured to manage a maintenance process for equipment. In one embodiment of the present invention, the method includes the steps of establishing a plurality of phases associated with said maintenance process, assigning a maintenance request to one of the phases; and establishing at least one process characteristic in response to the maintenance request and the phases.

This application claims the benefit of prior provisional patent application Serial No. 60/306,905 filed Jul. 20, 2001.

### TECHNICAL FIELD

This invention relates generally to a method and apparatus associated with a maintenance process, and more particularly, to a method and apparatus configured to manage a maintenance process.

### BACKGROUND

A timeline for maintenance management generally begins with a piece of equipment, having a particular symptom. The symptom is identified through a manual or automated inspection of the equipment. The inspection is followed up by a work order being placed for the equipment, followed by the actual scheduling of the equipment for maintenance, and then the actual maintenance being performed. Problems, or delays, in the process may result in the equipment failing before it is repaired. Equipment failure in the field, may be extremely costly to the equipment owner, such as a mine site, due to lost productivity. Traditionally maintenance management has been focused on the analysis of the maintenance scheduling. In many systems a problem in the maintenance process is not detected until the date for the scheduled equipment maintenance is missed. For example, lack of resources prevent the equipment from being repaired when it was supposed to be. However, analysis of only this portion of the process leads to the overall process having inefficiencies and/or being unresponsive, thereby causing ultimate equipment failure prior to repair.

The present invention is directed to overcoming one or more of the problems set forth above.

### SUMMARY OF THE INVENTION

In one aspect of the present invention, a method of managing a maintenance process for equipment is disclosed. The method includes the steps of establishing a plurality of phases associated with the maintenance process, assigning a maintenance request to one of the phases; and establishing at least one process characteristic in response to the maintenance request.

In another aspect of the present invention, a method of managing a maintenance backlog of equipment is disclosed. The method includes the steps of receiving a maintenance request, entering the maintenance request into a backlog, planning a pre-maintenance activity in response to the maintenance request, scheduling a maintenance activity in response to the pre-maintenance activity; and performing the maintenance activity.

In another aspect of the present invention, a computer system configured to analyze a maintenance process having a plurality of phases, including a maintenance request phase, a pre-scheduling phase, and a scheduling phase is disclosed. The computer system includes a first code portion configured to receive a maintenance request, a second code portion configured to manage pre-scheduling activity based on the maintenance request, a scheduling code portion configured to schedule a maintenance action for a piece of equipment associated with the maintenance request, and an analysis code portion configured to establish at least one process characteristic associated with the maintenance process.

### BRIEF DESCRIPTION OF THE DRAWINGS

FIG. 1 is an illustration of one embodiment of the steps that occur during a maintenance process;

FIG. 2 is an illustration of one embodiment of a method of managing a maintenance process for equipment; and

FIG. 3 is a block diagram of one embodiment of a computer system configured to manage a maintenance process for equipment.

### DETAILED DESCRIPTION

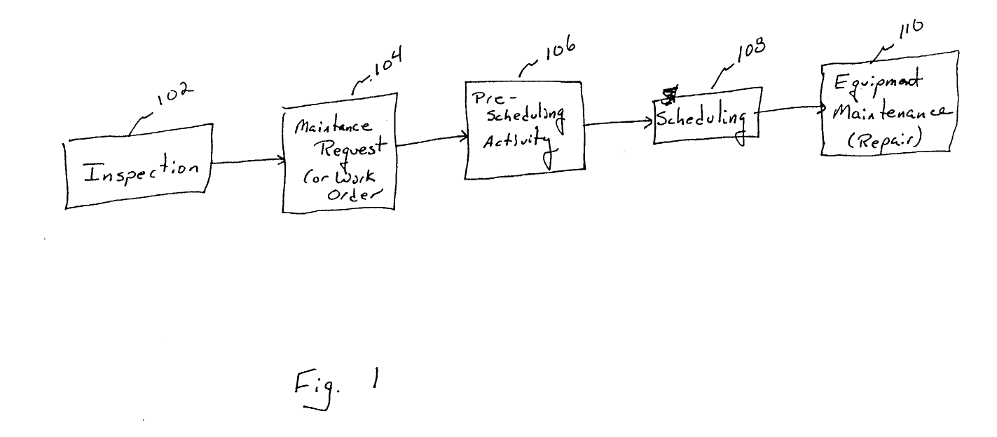

The present invention provides a method and apparatus of managing a maintenance process for equipment. In one embodiment, the equipment may be a machine, such as a mining truck, located at a work site. However, the present invention applies to other operating environments and types of equipment such a fleet of rental cars, taxis, factories or other environments where one or more types of equipment have maintenance needs. FIG. 1 is an illustration of one embodiment of the steps that may occur during the maintenance of the equipment. An inspection 102 of the equipment may occur. The inspection may be performed by an inspector, such as an operator of the equipment, an equipment inspector assigned to perform routine inspection of the equipment, a Fleet Analyst, or other form of inspector. In one form of an inspection, the inspector may be an internal health monitoring system on the equipment which is configured to electronically inspect the health of the systems on the equipment. The inspection may occur as a result of a symptom the equipment is exhibiting, or as a result of a preventive maintenance procedure or other reasons.

The equipment inspection may result in the identification of a needed equipment repair. For example, the equipment may be demonstrating a symptom that the inspector determines needs to be resolved. Alternatively, or additionally, the inspector may determine that the equipment is due for routine maintenance, or preventative maintenance. In any case, if maintenance repair is determined to be desired or needed, then a maintenance request, or work order is created. In one embodiment, the inspector completes a maintenance request form, which identifies the equipment, and the type of inspection performed, e.g., operator, field, preventative maintenance, internal health monitoring system, or other. In addition the form may include the symptom exhibited by the equipment, the maintenance action associated with the symptom, and the system associated with the problem, e.g., engine, electrical etc. In addition, the form may include a priority of the maintenance action, e.g., urgent, next preventative maintenance, when possible, or just to monitor the situation. The form may include an estimated time for the maintenance to occur by, such as equipment hours and/or man hours, and/or how long the maintenance action will take. The form may also include a parts request, e.g., the parts needed for the maintenance, and the tools needed for the maintenance, e.g., lift truck, crane, tire equipment, jack, etc. The form may be a paper form that is completed by the inspector, or may be an electronic form. For example, the inspector may have a portable computer, e.g., laptop or hand held computer, and may be able to enter the desired information onto an electronic form. The electronic form may be stored on the computer and later downloaded to a main computer, e.g., central computer system, or the electronic form may be electronically relayed to the central computer system by using wireless communication techniques, e.g., satellite communication, cellular telephone etc. In the event the maintenance request form is a paper form, the form may be delivered to a computer system, and entered into the computer by a user, e.g., scanning the form in, or manually entering the information etc. In one embodiment, an electronic form may be completed by the internal health monitoring system on the equipment itself, and then electronically transferred or relayed, e.g., via satellite communication or cellular phone network etc., to the computer system.

In one embodiment, once the maintenance form is completed, at least with regard to the relevant maintenance information, pre-scheduling activity 106 may occur. The pre-scheduling activity may include the identification of the parts and/or tools necessary for the maintenance, if they have not already been identified. Then the availability of the needed parts or tools may be identified. For example a determination may be made, automatically or manually, that the needed part is in a local inventory, or if the part needs to be ordered, either from a remote inventory location or a supplier etc. If the part, or tool, is not available then it may be ordered from the appropriate location. In one embodiment, the availability may include an expected availability date of the parts and/or tools. In one embodiment, once all of the needed parts and tools are available, then the equipment may be scheduled for the maintenance action. In an alternative embodiment, some or all of the pre-scheduling activities, may occur in parallel with the scheduling activity. For example, once the maintenance request is identified, the equipment is scheduled for maintenance at the same time the identification and ordering, if needed, of the necessary parts and tools occurs. For example, if a needed part is projected to be received in two weeks, then the equipment may be scheduled for repair at the next available opportunity, not to be earlier than two weeks.

In one embodiment, once the pre-scheduling activity is accomplished, the equipment may be scheduled for maintenance 108. The scheduling activity may include determining the next available opportunity to repair the equipment. The scheduling may include reviewing the priorities of the equipment to be scheduled along with those of the equipment already scheduled, and then modifying the current maintenance schedule as needed to accommodate the priorities of the equipment to be scheduled. Once the equipment has been scheduled for maintenance, the equipment may be maintained, or repaired at the scheduled time.

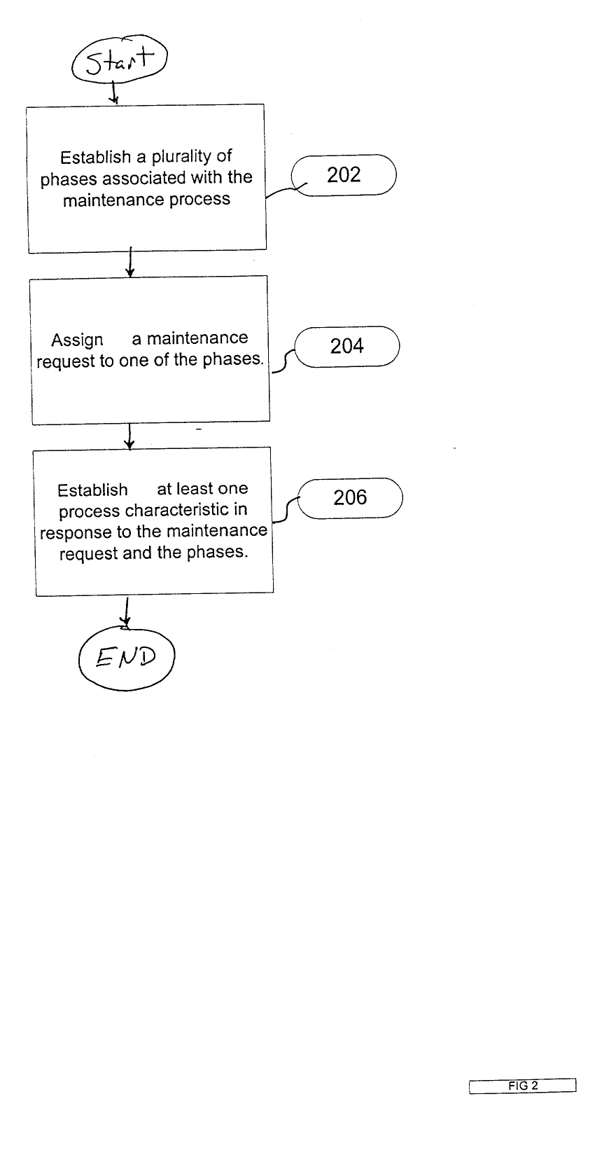

FIG. 2 illustrates one embodiment of the method of the present invention. The present invention includes a method of managing a maintenance process for equipment. The method includes the steps of establishing a plurality of phases associated with the maintenance process, assigning a maintenance request to one of the phases, and establishing at least one process characteristic in response to the maintenance request and the phases.

In a first control block 202, a plurality of phases associated with the maintenance process are established. In one embodiment, a maintenance process may include a maintenance request entry phase. The maintenance request phase may include the activity, and time period, between the creation of the maintenance request and the entry of the request into a computer system configured to facilitate the maintenance process. In one embodiment, the maintenance request entry phase also includes the inspection process. For example, the request entry phase may include the time period from the detection of a equipment symptom, by the equipment itself, e.g., internal health monitoring capabilities, or an inspector, to the time the request is entered into the system. The request entry may also include the time period from the symptom being detected to the time the inspection occurs. The request phase may also include the period from the time the inspection occurs to the time the work request is entered into the system.

In one embodiment, the maintenance process may include a pre-scheduling phase. The pre-scheduling phase may also be referred to as a planning stage. The pre-scheduling phase may include the time period, and activity, between the time the maintenance request is entered into the system up to the time period the equipment and associated activities are ready to be scheduled. For example, the pre-scheduling phase may include activity of identifying and/or arranging the availability of the needed parts and tools to perform the requested maintenance. This phase may therefore include the activity of ordering parts and/or tools from remote locations or suppliers, and receiving those parts and/or tools.

In one embodiment, the process includes a scheduling phase. The scheduling phase may include the time period between when the equipment is ready to be scheduled, e.g., the parts and tools are available, and when the equipment is repaired. The scheduling phase may include the activity of scheduling the equipment for maintenance and then bringing the equipment in and repairing it. In one embodiment, the scheduling phase may overlap with the pre-scheduling phase. For example scheduling phase may schedule the maintenance of the equipment before all the parts and tools are available. In addition, the equipment maintenance may be scheduled prior to know when the parts and tools will be available. The schedule may then be modified once the availability of the parts and tools are identified.

In a second control block 204, a maintenance request is assigned to one of the phases. For example, when a maintenance request is created, the maintenance request would be included in the maintenance request entry phase. Once the maintenance request and associated information (or portion thereof) is entered into the system, the request may be assigned to, or considered to be in the pre-scheduling phase. This phase may include the initial recognition of a maintenance issue, and/or the collection of relevant information to establish the maintenance request. Once the necessary activities are completed to be able to schedule the equipment for maintenance, the maintenance request may be assigned to, or considered to be part of the scheduling phase. In this manner, a maintenance request may transition through the phases of the maintenance process. In addition, each phase may have one or more maintenance request associated with multiple pieces of equipment.

In a third control block 206, at least one process characteristic is established in response to the maintenance request and the phases. In one embodiment, the number of maintenance requests in the process are determined. For example the number of maintenance request of each of the phases are added together. Based on this number, a process characteristic such as a risk indicator may be determined. The risk indicator provides an indication of the risk of failure of one or more of the pieces of equipment. For example, if the number of request in the process is large, then there is a higher probability that one of the pieces of equipment will fail before the appropriate repair takes place. A failure in this context includes the failure of the equipment, e.g., equipment in the field, prior to the time of the equipment's scheduled repair. In an environment such as a mine site, equipment failure, especially in the field, is an issue that is desirably avoided. The risk indicator provides a metric which indicates the chances of a failure of at least piece of one equipment prior to repair. The risk indicator may be an indicator that increases in response to increases in the number of maintenance request (i.e., risk increases as the number of maintenance request increase). Alternatively the risk indicator may include more complex analysis. For example, the risk indicator may be dependent on the phase each of the maintenance request is in, severity, or urgency, of the maintenance request, etc. In one embodiment each of these factors may be weighted, and the risk indicator is an analysis of the weighted factors to establish an overall risk of one or more equipment failures. For example, even if the number of maintenance request in the scheduling phase is low, if all of the request are urgent, may lead to severe equipment damage upon failure, and have high estimated repair times, then the risk may be as high, or higher than if the scheduling phase had more request of a low urgency/severity and or low estimated repair times. In addition, the number of maintenance request in the process may be used to establish a work load indicator, e.g., how much work is in the system to be performed.

In one embodiment, the process characteristic may include the number of maintenance request generated. The number of maintenance request generated may be used to evaluate the methods used to detect equipment symptoms, e.g., internal health monitoring capabilities, inspection processes etc. For example, if there are a relatively small number of maintenance requests, and yet equipment failures are occurring, then the detection methods may be inadequate. Alternatively if there are a large number of maintenance request, and a small number of equipment failures, then in one embodiment, the inspection processes may be viewed as meeting the needs of the maintenance process. Therefore, the number of maintenance request generated may be used to establish a detection indicator, where the detection indicator is indicative of the quality of the symptom detection processes used.

In one embodiment, the process characteristic may include a estimated repair time established in response to the maintenance request. For example, the maintenance requests may have an estimated repair time associated with it, e.g., equipment down time, and/or man hours. Summing the repair time provides an indication of the severity of the work load in the process, and may also be used as a factor in determining the risk of having an equipment failure.

In one embodiment, the process characteristic may include a responsiveness indicator established in response to one or more of the maintenance request. For example, the age of the maintenance request may be established. In one embodiment the age of each maintenance request may be compared with a threshold age, or time period, e.g., 30 days, to determine how many of the maintenance request are older than the threshold time period. Alternatively a percentage of the maintenance requests over the threshold time period may be established. The number, or percentage, of the maintenance request over a threshold time period may be indicative of the quality of the responsiveness of the system. For example, if there are a large percentage of maintenance request over a threshold time period, e.g., 30 days, then the system may be deemed to be inadequate with regard to maintenance responsiveness. Lengthy delays in resolving the maintenance request increases the risk of failure of the equipment. In addition, the average age of the maintenance request may be determined and compared with a desired average age. The result of the comparison may be used to determine the responsiveness of the system, such as how long does it take on average to respond to a maintenance request, how fast may the process react to a maintenance request, how fast may the process respond to an urgent maintenance request etc.

In one embodiment, the process characteristic may include the number of maintenance request in a phase. The number of maintenance request in a phase may be used to identify bottlenecks in the process. They may also be used to identify risks in the process, and as a responsiveness indicator. For example, if the number of request in the scheduling phase exceeds a threshold, then in one embodiment, a determination is made that too many equipment are waiting to be repaired. Again, in one embodiment, the more pieces of equipment that are waiting to be repaired, the higher the risk of having a equipment failure occur prior to the scheduled repair. Therefore, if the number exceeds a threshold number, then a manual or automatic recommendation may be made regarding how to reduce the number of equipment scheduled for repair, e.g., begin working overtime, hire additional help, outsource the maintenance etc. In addition, the number of request in the pre-scheduling, or planning, phase being high is an indication that there may be a potential problem in the parts or tool availability process. For example, the number of requests waiting to have parts ordered may be resolved by hiring additional parts procurement staff, scheduling overtime etc. Alternatively, an electronic parts ordering system may be utilized to ensure that once a part is identified as being needed as part of the repair, the computer system automatically checks a database of local inventory parts. If the part is unavailable, the computer system may electronically identify the location of the needed part, and electronically place an order for the part. Thereby reducing the time delay potentially associated with parts ordering. In addition, the number of request in the pre-scheduling being high may be an indication that parts and or tools are not being received in a timely manner from the remote inventory location or supplier etc. Therefore, the process has identified that improved supplier responsiveness, for example, is needed to improve the responsiveness of the process.

In addition, the number of maintenance request in the maintenance request entry phase may be an indicator of efficiency of entering the information into the system. For example, if the number exceeds a threshold, then there may be an indication that addition inspectors, or request entry personnel are needed, or overtime may be scheduled etc.

In one embodiment, the process characteristic may include the number of maintenance request generated be a particular type of inspection may be established. For example, the number of maintenance request established by the internal health monitoring systems on the machine, the operators, the inspectors, or the Field Analyst may be established. These numbers may be used to identify the more effective inspection techniques, and also determine which inspection techniques are not being as successful as desired. A small number of maintenance request generated by internal health monitoring systems may indicate the health monitoring systems are not as robust as desired, and need to be enhanced. For example, if there are a small number of prognostic failure request, yet failures are occurring, the prognostic failure indicators may need to be more robust.

In one embodiment, the process characteristic may include the number of maintenance request associated with a particular equipment system or equipment type may be established. The number may be used to identify which systems, or piece of equipment is more prone to problems than others. In one embodiment, identifying a problem prone part or system may prompt a review of how the system is used and maintained to determine if there are any improved operation techniques that may be used to improve the uptime of the system.

In one embodiment, the processes characteristic may be a comparison of the scheduled maintenance versus the unscheduled maintenance. The comparison may be based on the number of maintenance events, the number of maintenance hours associated with the maintenance events, and/or the number of hours the equipment is down. Scheduled maintenance is associated with scheduled maintenance request that have passed through the phases of the process. An event may be a maintenance request, a maintenance activity, or a group of maintenance activities. Unscheduled maintenance refers to equipment that unexpectedly fails and is having to be quickly repaired, or repaired as quickly as possible. A significant amount of unscheduled maintenance may indicate that inspection processes are not as thorough as desired, or functioning as desired. Significant number of unscheduled maintenance may also account for other issues in the process, such as bottlenecks in some phases in the process because the failed equipment is essentially having to cut line (in the maintenance line), in order to minimize its down time. Therefore, there are delays and bottlenecks in maintaining the equipment scheduled for maintenance, thereby possibly causing a ripple effect throughout the maintenance process that may have an adverse effect in the attempt to efficiently and effectively manage the maintenance process.

The process characteristic may include service accuracy. Service accuracy includes the ability to perform a desired maintenance procedure within a desired time period. For example, the service procedure may be associated with oil, filter, or grease changes. The service accuracy may provide an indication of whether these procedures are occurring when desired, on average and individually. If they aren't occurring when desired, the service accuracy may include metrics indicative of how much of a delay there was, and the impact of the delay. In addition, the process may be reviewed in whole to determine why those delays occurred. For example, if a piece of equipment was due an oil change, and missed the desired maintenance date by two weeks, the process could be reviewed from the point of time the maintenance request was submitted (or the inspection first identified the need for the oil change), through the time the maintenance action occurred. Therefore a determination may be made as to whether there was a delay in identifying the need for the maintenance, a delay in receiving the parts, a delay in scheduling the equipment, and/or a delay in actually performing the maintenance. For example, several unscheduled maintenance activities may have occurred, delaying the routine maintenance on this and other machines. In this manner, the process may be reviewed to identify potential weaknesses which may be improved upon. For example, if unexpected maintenance activities are repeatedly causing unacceptable delays in other activities, perhaps additional resources (e.g., man power, additional shifts, additional tools/service bays) may be needed to support a smooth flow of maintenance activities. In addition, the unexpected maintenance activities may be reviewed to establish the cause of the needed maintenance and steps taken to eliminate or reduce the unexpected maintenance. For example, improved inspection procedures may be initiated.

The process characteristic may including trending analysis of the one or more other process characteristics to establish whether the overall process is improving. These trending analysis may also be used to establish the impacts of the number of pieces of equipment to be maintained on the process, the type of equipment to be maintained on the process, the applications of the equipment to be maintained, and/or the weather or time of year of the maintenance, on the process etc. These trending analysis may provide valuable information in modifying the maintenance process to improve the efficiency and effectiveness of the process. For example, during long periods of rugged operation, additional manpower may be planned for and utilized to address an increase in maintenance needs.

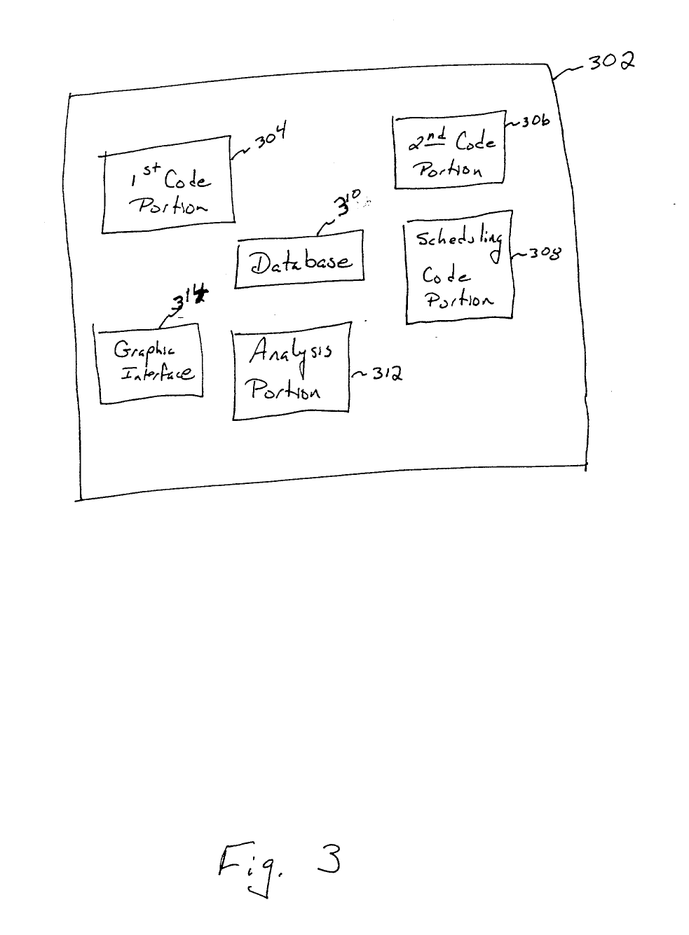

FIG. 3 illustrates one embodiment of a computer system 302 configured to manage a maintenance process. In one embodiment, the computer system includes a first code portion 304 configured to receive a maintenance request, or information associated with a maintenance request. In one example, the first code portion 304 receives a maintenance request form in an electronic format. For example, the request may be received from another computer, e.g., laptop or hand held computer, downloading the information. Alternatively the information may be received over a wireless data link. In addition, the first code portion 304 may include a user interface which enables a user to manually enter the maintenance request information into the computer. The maintenance request information may include information associated with the inspection process, e.g., when was the inspection scheduled, when did the inspection take place etc. In one embodiment, the maintenance request forms may be stored by the first code portion 304 in a data base 310 located on the computer system. The stored maintenance request forms may include an indicator of which phase of the maintenance process they are in, e.g., the maintenance request entry phase, pre-scheduling phase, or scheduling phase.

In one embodiment, the computer system 302 may include a second code portion configured to manage pre-scheduling activity associated with the maintenance request form. For example, in one embodiment, the second code portion 306 will identify the availability of parts and/or tools. In one embodiment, once the maintenance request form is entered into the system, the second code portion 306 identifies the parts and/or tools needed for the repair from the stored request form. The second code portion 306 then electronically determines if the needed items are available locally, e.g., in on-site inventory, or are located at a remote inventory location. In one embodiment, if the part or tool is unavailable, then the second code portion 306 is configured to electronically order the part from a supplier. In one embodiment, the second code portion 306 is configured to establish an expected availability date for the needed parts so that the equipment maintenance may be scheduled in advance of receiving the items, if desired. The second code portion 306 may generate an expected availability message indicating the availability of the parts and/or tools. In addition, the second code portion 306 may be electronically notified when unavailable parts and or tools arrive. In this manner, the second code portion 306 is configured to generate a pre-scheduling complete indicator, e.g., message or flag, indicating that pre-scheduling activity is complete.

In one embodiment, the computer system includes a scheduling code portion 308. The scheduling code portion 308 is configured to schedule the maintenance for a piece of equipment in response to the maintenance request form. The scheduling code portion 308 may determine when to schedule the equipment for maintenance. In one embodiment, the determination may be made upon receipt of the pre-scheduling complete message, or expected availability message. Alternatively, the maintenance request may be scheduled immediately, then a cross check may be performed with the pre-scheduling phase to determine when the parts and tools will be available. The scheduled maintenance may be modified accordingly once a determination of the parts and/or tool availability is performed. Alternatively, the information may be entered manually into the computer system, e.g., stored with the electronic form, at which time the third code portion 308 is activated to schedule the maintenance. In one embodiment, a user may activate a schedule maintenance button located on the user interface. Once activated, the button activates the third code portion 308 to schedule and track the maintenance of the equipment. In one embodiment, a maintenance complete notice is delivered to the third code portion 308 upon completion of the maintenance activity. Additional information may be entered at this time regarding the maintenance procedure. For example, information may be entered into the system 302 indicating the actual repairs that occurred. In one embodiment, this information may be used to compare the initial maintenance request to the actual repair action in order to determine the accuracy of the inspection process.

In one embodiment, the computer system 302 includes an analysis code portion 312. The analysis code portion is configured to analyze the information associated with the maintenance process and establish associated process characteristics. For example, the analysis code portion 312 may be configured to determine process characteristics such as the number of maintenance request in the system, the estimated time to repair for the maintenance request, the percentage, or number, of maintenance request older than thirty days, the quantity of maintenance request associated with each phase of the maintenance process, the number of maintenance request per type of inspection, the number of maintenance request per system, and the number of maintenance request per system. In one embodiment, the computer system 302 includes a graphical user interface 314 which enables the graphical display of the results of the analysis of the analysis code portion 312. In one embodiment, the analysis code portion 312 is also configured to establish recommendations in response to the analysis. For example, if the number of maintenance request in the schedule phase exceeds a threshold, the analysis code portion 312 may recommend that the scheduling process be reviewed. For example, in one embodiment, the analysis code portion 312 may recommend additional resources be applied to the maintenance process, example additional personell hired (part time or full time), or overtime used, in order to reduce the number of pieces of equipment waiting to be repaired. In addition, trending analysis may be performed that indicates the number of pieces of equipment waiting to be maintained is increasing. In addition, the system may be able to determine if the overall number of pieces of equipment associated with the maintenance process has increased. The analysis portion 312 may perform a cost benefit analysis to determine if additional service bays, or maintenance tools should be acquired to reduce the number of pieces of equipment waiting to be maintained, and/or the length of the maintenance process. The cost benefit analysis may review the cost of the additional resources against factors such as, the possible overhead of having machines wait to be maintained, the cost of having a piece of equipment fail in the field, the frequency of field failures etc.

In addition, the analysis code portion 312 may be able to rate the overall maintenance process. For example a list of process characteristics, or indicators may be established, such as the quantity of the maintenance, the estimated repair time, the percentage of maintenance request over thirty days etc. The analysis code portion 312 may apply a weighting factor to one or more of these process indicators. The weighting factors may be dynamically determined, or pre-determined values. In addition, the weighting factors may be used to assign a relative importance to each of the indicators. For example, the process indicator indicative of the number of equipment waiting to be repaired may be provided a higher weight than the maintenance request per type of inspection because the number of equipment waiting to be repaired may be a better indicator of overall maintenance process efficiency and effectiveness. Therefore, upon a users request, on in an automated manner, the analysis code portion 312 may provide an indication of the effectiveness of the maintenance process, or a portion thereof. In addition, these weighted factors may be used to determine the overall risk, or probability of equipment failure prior to the scheduled repair.

The code portions, database, user interface, and graphics interface may run on one or more processors, located on one or more computers. For example, the computer system 302 may be a single computer, or may include multiple computers. In one embodiment, the computing system 302 is web enabled, such that access to the system may occur via the internet.

In one embodiment, the computing system is able to assign a maintenance request to one of the phases, e.g., maintenance request, pre-scheduling, and scheduling phases. In addition, at least one process characteristic may be established in response to the phases and the maintenance request.

Other aspects, objects, and embodiments of the present invention can be obtained from a study of the drawings, the disclosure, and the claims.

### INDUSTRIAL APPLICABILITY

The present invention includes a method and system configured to manage a maintenance process for equipment. The method includes the steps of establishing a plurality of phases associated with said maintenance process, assigning a maintenance request to one of the phases, and establishing at least one process characteristic in response to the maintenance request and the phases. In one embodiment, the present invention is configured to establish a database of equipment request, and analyze the progress of these equipment request. For example, the present invention is configured to analyze the phases of the process to identify problems with the phases or process in general. For example, is there a bottleneck in the process in waiting for parts to arrive. If so, the system will identify the bottleneck and may recommend a course of action. For example, maybe additional contact needs to be made with an identified supplier to get them to increase production, or increase delivery efficiency etc. Therefore the present invention may be used as an analysis tool to access the effectiveness and/or responsiveness of a maintenance process, or portions thereof.

What is claimed is:

1. A method of managing a maintenance process for equipment, comprising the steps of:
establishing a plurality of phases associated with said maintenance process;
assigning a maintenance request to one of said phases; and
establishing at least one process characteristic in response to said maintenance request and said phases.

2. A method, as set forth in claim 1, wherein a plurality of maintenance request have been assigned to one or more of said phases.

3. A method, as set forth in claim 1, wherein each said phase includes a plurality of maintenance request.

4. A method, as set forth in claim 2, wherein the step of establishing said process characteristic, includes the step of establishing said process characteristic in response to a number of maintenance request in a phase.

5. A method, as set forth in claim 4, wherein the step of establishing said process characteristic in response to said number of maintenance request in a phase, includes the step of establishing said process characteristic in response to said number of maintenance request in a phase exceeding a request threshold.

6. A method, as set forth in claim 5, further comprising the step of automatically recommending a process modification in response to said maintenance request in a phase exceeding said request threshold.

7. A method, as set forth in claim 6, wherein said recommended process modification includes at least one of a change in work force, an overtime recommendation, and an change in physical resources.

8. A method, as set forth in claim 2, wherein the step of establishing said process characteristic further includes the steps of:
establishing a number of scheduled maintenance events;
establishing a number of unscheduled maintenance events;
comparing said number of scheduled maintenance events with said unscheduled maintenance events and
establishing said process characteristic in response to said comparison.

9. A method, as set forth in claim 8, wherein the step of establishing said process characteristic further includes the step of:
establishing a service accuracy associated with at least one machine request.

10. A method, as set forth in claim 2, wherein the step of establishing at least one process characteristic further comprises the steps of:
establishing a number of maintenance events in said process; and
establishing a risk indicator in response to said maintenance event number, said risk indicator being indicative of a risk of failure of one or more pieces of equipment.

11. A method, as set forth in claim 2, wherein the step of establishing at least one process characteristic further comprises the steps of:
establishing a number of maintenance events in said process; and
establishing a detection indicator in response to said maintenance event number, said detection indicator being indicative of a quality of an equipment inspection process.

12. A method, as set forth in claim 2, wherein the step of establishing at least one process characteristic further comprises the steps of:
establishing an estimated repair time associated with said maintenance request.

13. A method, as set forth in claim 2, wherein the step of establishing at least one process characteristic further comprises the step of determining one of a number and a percentage of maintenance request older than a threshold time period.

14. A method, as set forth in claim 13, further including the step of establishing a responsiveness indicator, said responsiveness indicator being indicative of the quality of process response time.

15. A method, as set forth in claim 2, wherein the step of establishing at least one process characteristic further comprises the steps of:
establishing a number of maintenance events in one of said phases; and
establishing said process characteristic in response to said maintenance event number.

16. A method, as set forth in claim 2, wherein said maintenance process includes at least one inspection process.

17. A method, as set forth in claim 16, wherein the step of establishing at least one process characteristic further comprises the steps of:
establishing a number of maintenance requests associated with said at least one inspection process.

18. A method, as set forth in claim 2, wherein the equipment includes a plurality of systems, and wherein the step of establishing at least one process characteristic further comprises the steps of:
establishing a number of maintenance events associated with one of said plurality of systems.

19. A method, as set forth in claim 2, wherein the step of establishing at least one process characteristic includes the step of establishing a trend associated with a plurality of maintenance request.

20. A method, as set forth in claim 19, wherein the step of establishing said trend includes the step of establishing said trend in response to at least one of a number of pieces of said equipment to be maintained, an application associated with said equipment, a time of year associated with said maintenance request, and a type of equipment to be maintained.

21. A method, as set forth in claim 20, further comprising the step of automatically recommending a process modification is response to said trend.

22. A method, as set forth in claim 21, wherein said recommendation includes at least one of an modified work force, an overtime recommendation, and an change in physical resources.

23. A method of managing a maintenance backlog of equipment, comprising the steps of:
receiving a maintenance request;
entering said maintenance request into a backlog;
planning a pre-maintenance activity in response to said maintenance request;
scheduling a maintenance activity in response to said pre-maintenance activity; and
performing said maintenance activity.

24. A computer system configured to analyze a maintenance process having a plurality of phases, including a maintenance request phase, a pre-scheduling phase, and a scheduling phase, comprising:
a first code portion configured to receive a maintenance request;
a second code portion configured to manage pre-scheduling activity based on said maintenance request;
a scheduling code portion configured to schedule a maintenance action for a piece of equipment associated with said maintenance request; and
an analysis code portion configured to establish at least one process characteristic associated with said maintenance process.
